(19) United States
(12) Patent Application Publication
(10) Pub. No.: US 2023/0321864 A1
(43) Pub. Date: Oct. 12, 2023

(54) EQUIPPING DEVICE FOR RECEIVING A SUPPLY, AND COATING MATERIAL

(71) Applicant: HOMAG GmbH, Schopfloch (DE)

(72) Inventors: Patrick MÜLLER, Glatten (DE); Stefan LEIPERSBERGER, Herzogsweiler (DE); Jwalant VAISHNAV, Wiesbaden (DE); Daniel SEID, Tübingen (DE); Jochen PAUL, Eggstätt (DE)

(21) Appl. No.: 18/024,961

(22) PCT Filed: Sep. 6, 2021
(86) PCT No.: PCT/EP2021/074462

§ 371 Date: Mar. 6, 2023

(30) Foreign Application Priority Data
Sep. 7, 2020 (DE) 10 2020 123 271.3

(51) Int. Cl. B27D 5/00

(52) U.S. Cl. CPC B27D 5/003

(57) ABSTRACT

An equipping device can accommodate a supply of coating material for a coating machine or a material storage system. The coating material can be kept available and/or evaluated by means of such an equipping device. Additionally, the present disclose also relates to workpieces in the field of furniture and components industry that can be coated with a coating material that can help the user identify the quantity of coating material being used or remaining.

### TECHNICAL FIELD

The invention relates to an equipping device for accommodating a supply of coating material. In particular, a supply of coating material for a coating machine or a material storage system can be kept available and/or evaluated by means of such an equipping device. The invention also relates to a coating material. Workpieces in the field of furniture and components industry can be coated with such a coating material.

### PRIOR ART

When processing plate-shaped workpieces, coating materials are often used to coat the narrow side(s). Such coating materials are also referred to as edge bands.

For processing the coating material with a coating device, in particular an edge banding machine, the coating material is preferably rotatably mounted in roll form on a roll holder and fed from there to the coating device. The coating material can be accommodated horizontally in the form of a plate or vertically in the form of a magazine or a standing device. Various approaches are already known for handling or managing such coating materials.

For example, European patent application EP 1 860 596 A1 is known, which relates to an identification device for resource management of endless materials. The identification device for attachment to endless materials comprises a carrier associated with the endless materials and a wirelessly writable and readable information storage unit provided on the carrier. A system for identification and management of endless materials comprises an identification device that can be attached to endless materials, a storage magazine for accommodating a plurality of units, a transport unit for conveying the endless materials unit from the storage magazine into a processing machine, and a read/write device attachable to the processing machine for wirelessly writing/reading the information storage unit.

As one piece of information about a particular coating material, for example, an indication of its length is printed on a sticker on the inside of the coating material. However, there is the requirement to make information about a particular coating material available to a user not only in the initial state, but also to provide information about the quantity of coating material still available at any point in time, so that appropriate resource planning can be performed and times for changing a coating material can be specifically planned.

### DESCRIPTION OF THE INVENTION

The invention is based on the object of enabling improved resource planning for coating material, in order, in particular, to achieve as efficient a use of the coating material as possible.

For this purpose, an equipping device with the features according to claim 1 is provided. Further preferred embodiments are specified in the dependent claims. Furthermore, a coating material is provided.

An equipping device for accommodating a supply of coating material which can be used for coating a plate-shaped workpiece, in particular a narrow side/narrow surface of a plate-shaped workpiece, comprises at least one determining means for determining a parameter of the supply of coating material.

With the aid of the equipping device according to the invention, a remaining quantity of a coating material can be determined on the basis of the detected parameter. In particular, it is not necessary to unroll the coating material or to take further elaborate measures. Furthermore, it can be provided to read off the quantity or remaining length of the coating material directly at the equipping device. Thus, the user can determine the quantity or remaining length of the coating material during or immediately after production.

The information regarding the quantity or remaining length of coating material can be used to know the total stock of coating material of one type for materials management, for example, to trigger reorders. Furthermore, the information can be used for a recalculation of an order, or trigger a request to refill the coating material.

The information obtained in this way can be determined and transferred to further systems (machine control, edge band management, ERP system, material management and ordering systems of third-party suppliers).

The equipping device may be used in combination with a coating machine or in combination with a storage facility/material store for coating material or may be suitable or designed for this use. Accordingly, the equipping device may be used, for example, to keep the coating material available at a coating machine, or the equipping device is placed adjacent to or at a material store so that a worker can determine the parameter of the supply of coating material prior to storing the coating material.

The coating material is provided in particular for coating a narrow side/narrow surface of a plate-shaped workpiece. In this case, the coating material is in particular strip-shaped. According to a further embodiment, the coating material can be designed for coating a wide surface.

For the acquisition of the information an optoelectronic sensor can be used, which is connected to a control and/or storage means.

This gives a user the advantage that, with relatively little effort, a stock of coating material can be accurately recorded and, accordingly, in materials management, the coating materials can be reordered, a reorder can be placed or refilling can be carried out at the machine even before a material bottleneck occurs, so that production can continue smoothly.

Furthermore, reading errors can be avoided, since the determining means is directly associated with a specific coating material by the equipping device, namely the coating material accommodated in the equipping device.

According to one embodiment, the determining means comprises a first determining means for determining a first parameter of the coating material and a second determining means for determining a second parameter of the coating material. Thus, a remaining quantity of a coating material can be reliably determined taking into account the parameters.

It is preferred that the supply of coating material to be accommodated is an edge band roll for coating a narrow side of the plate-shaped workpiece, wherein the edge band roll has an inner dimension, preferably an inner diameter, and an outer dimension, preferably an outer diameter, and wherein the first parameter is the inner dimension, and wherein the second parameter is the outer dimension. Thus, a remaining quantity of the coating material can be determined by subtracting the inner dimension from the outer dimension and taking into account the thickness of the coating material.

According to one embodiment, it is provided that the first determining means comprises an actuatable, preferably rotatably actuatable, manipulator, wherein different values of the first parameter are associated with different positions of the manipulator. Thus, a parameter can be determined intuitively.

The first determining means may further comprise at least one stop which can be brought at least into a first position and into a second position by actuation of the manipulator, wherein the first position is associated with a first value of the first parameter, and wherein the second position is associated with a second value of the first parameter. Thus, parameter detection can be performed in an intuitive and more reliable manner. Further positions, diameters and/or scales may be provided. For example, a first position indicates a first inner diameter of 150 mm, a second position indicates a second inner diameter of 200 mm, and further positions indicate inner diameters of 300 mm and 400 mm.

Preferably, the first position and the second position are different positions of a scale that can be read or detected accordingly.

According to one embodiment, it is provided that the first position corresponds to an actual position of an inner surface of an edge band roll having a first inner dimension, and in which the second position corresponds to an actual position of an inner surface of a coating material, in particular an edge band roll, having a second inner dimension.

Furthermore, the stop can be brought into contact with an inner surface of the coating material to be accommodated, in particular an edge band roll, by actuation of the manipulator. In this way, sources of error in the determination of the parameter can be avoided.

It is preferred that the second determining means comprises a plurality of scale groups including a first scale group and a second scale group, wherein the equipping device is further configured such that bringing the manipulator into the first position causes a preselection of a first scale group of the second determining means, and that bringing the manipulator into the second position causes a preselection of a second scale group of the second determining means.

According to a further embodiment, it is provided that the first determining means is connected to the second determining means by means of an actuator element. In this context, it is further preferred that the actuator element comprises a gear unit such as a spur gear, a planetary gear, a belt gear, a friction gear and/or a rack-and-pinion gear; a rigid connection between the manipulator and at least one component of the second determining means, and/or a drive such as an electrically, hydraulically or pneumatically operable drive. In the case of a gear unit, for example, a certain transmission ratio may be provided to facilitate handling. A drive also assists the user.

According to a further embodiment, it is provided that the equipping device is configured in such a way that bringing the manipulator into the first position moves the first scale group of the second determining means into a display area, preferably designed as a viewing window, and bringing the manipulator into the second position moves the second scale group of the second determining means into the display area. This increases the flexibility of the equipping device.

It is preferred that the first scale group comprises at least a first scale and a second scale, wherein the first scale is adapted to indicate a remaining quantity of a first roll of coating material (edge band) to be provided, which has a first thickness, and wherein the second scale is adapted to indicate a remaining quantity of a second roll of coating material (edge band) to be prepared, which has a second thickness. Thus, the equipping device is prepared according to different coating materials. Accordingly, a rapid determination of the remaining quantity of edge band/coating material can be made. The scales can also take into account more than two thicknesses of coating material.

The determining means, in particular the first and/or second determining means, may comprise one or more sensors, in particular one or more cameras; one or more optoelectronic sensors; one or more capacitive sensors; one or more ultrasonic sensors; one or more radar sensors; and/or one or more light barriers. In this way, the corresponding parameter can be detected at any time or continuously. The second determining means can be integrated into a monitoring or control system due to the corresponding structure.

The first determining means may comprise an input means for inputting the first parameter and optionally for inputting a third parameter, for example a thickness of the coating material. This facilitates the evaluation. If coating materials are used that differ in thickness, in particular edge band thicknesses, it is possible to react flexibly accordingly.

It may further be provided that the determining means comprises weighing scales for determining a mass of the supply of coating material. Based on the determined mass, the quantity, and thus also the length, of the remaining coating material can be calculated.

According to a further embodiment, it is provided that the equipping device comprises an output device for outputting a remaining quantity of a (supply of) coating material to be prepared. For example, this may be a digital display, an illuminant, or a marker that can be activated.

Furthermore, a coating machine for coating one side, in particular a narrow side, of a plate-shaped workpiece is provided. The coating machine can be adapted to provide plate-shaped workpieces with a coating material on the narrow side. The coating machine comprises at least one coating unit and an equipping device according to any of the above embodiments. Such a coating unit can, for example, be equipped with an embossing roller to provide the coating material applied to a workpiece with a three-dimensional structure.

According to another objective, a material storage system for accommodating coating material is provided, wherein the material storage system comprises an equipping device according to any of the above embodiments. The equipping device may be placed adjacent to or at a material store (e.g. shelf) of the material storage system such that a worker can determine the parameter of the supply of coating material prior to storing the coating material, for example. Thus, storage can be monitored or documented accordingly.

Among other things, this allows efficient resource planning to be performed in order to be able, for example, to specifically plan non-productive times for changing coating material.

Such a coating machine may comprise an energy source such as a hot air source, a laser, a microwave source, an infrared source, an LED source, a plasma source, or the like.

A workpiece that is coated with the coating machine can, in particular, consist at least in parts of wood, wood material, composite material, plastic, aluminum, or the like.

According to a further aspect, a coating material for coating a plate-shaped workpiece is provided, wherein the workpiece preferably consists at least in parts of wood, wood material, composite material, plastic, aluminum, or the like. The coating material has a means for indicating a remaining quantity of coating material.

Such a coating material may be a coating material for coating a narrow side of a plate-shaped workpiece, in particular an edge band. Such a coating material can be formed, for example, from plastic or a real wood veneer.

According to another objective, the coating material can be an adhesive film that can be used to apply a decorative material, in particular an edge band.

The coating material may be provided with an activatable layer that is activatable, for example, with an energy source such as a hot air source, a laser, a microwave source, an infrared source, an LED source, a plasma source, or the like. Alternatively, the coating material may be configured such that an adhesive or adhesion-conferring layer can be applied to one side in the course of a coating process.

Using the coating material, a remaining quantity or remaining length can be determined without unrolling the coating material. Rather, the quantity or remaining length of the coating material can be determined or detected directly on the coating material.

The coating material is preferably configured as an edge band roll for coating a narrow side of the plate-shaped workpiece. Furthermore, it can be provided that the edge band roll has an (imaginary) central axis. Furthermore, it is preferred that the edge band has a length, a width and a thickness when unwound.

The means for indicating a remaining quantity of coating material may comprise a scale so that a simple and reliable determination of the remaining quantity or remaining length of coating material is made possible.

Preferably, the coating material has a contact surface for contacting the plate-shaped workpiece and a decorative surface opposite the contact surface, the scale being provided on the contact surface. Thus, the scale can remain on the coating material without affecting the optical appearance of the coated workpiece. The contact surface can be a surface that is provided with an adhesive layer or that comes into contact when attached to a workpiece. Alternatively, the contact surface may be an activatable layer that can be activated with an energy source to cause the activatable layer to develop adhesive properties. Also, the contact surface may be the side of the coating material where the activatable layer is provided.

It is preferred that the scale further extends in the longitudinal direction of the edge band so that the user is provided with advantageous assistance.

Alternatively, it may be provided that the scale is provided on an end face of the coating material, in particular the edge band roll, the scale preferably not being provided on the contact surface and/or the decorative surface of the coating material, in particular the edge band. Thus, it is possible to read the scale when the coating material is placed on a surface, for example in an equipping device.

According to a further embodiment, it is provided that the scale is radially oriented with respect to the central axis of the coating material, in particular the edge band roll.

The scale can extend helically with respect to the central axis of the coating material, in particular the edge band roll.

The scale can further be provided on the contact surface and/or the decorative surface of the coating material, in particular the edge band, and extend in the longitudinal direction of the edge band, wherein a free area arranged centrally on the decorative surface in the width direction of the coating material, in particular the edge band, has no scale. Thus, the scale located in an edge area can be removed when post-processing the coating material applied to the workpiece.

In a further embodiment, it is provided that the free area occupies at least 50%, preferably at least 75%, and particularly preferably at least 90% of the edge band width.

It is preferred that the means for indicating a remaining quantity of coating material is an imprint so that the corresponding information is securely linked to the coating material. Also, it is possible that the means for indicating a remaining quantity of coating material is provided as a notch or gouge in the coating material.

The means for indicating a remaining quantity may be a tape such that a cost-effective implementation is ensured.

Furthermore, the means for indicating a remaining quantity of coating material may be detachably connected to the coating material. Accordingly, the means for indicating the remaining quantity can be attached to the coating material after it has been produced.

It is preferred that the means for indicating a remaining quantity of coating material is a measuring tape that is wound parallel to the coating material, in particular the edge band, with respect to a radial direction of the coating material, in particular the edge band roll.

The coating material can be used in the previously described equipping device.

Furthermore, a system of a coating material according to any of the aspects described above and an equipping device according to any of the aspects described above may be provided.

A further objective relates to a method for determining a quantity or remaining length of a coating material, in particular a coating material according to any of the aspects described above and/or using an equipping device according to any of the aspects described above.

### BRIEF DESCRIPTION OF THE DRAWINGS

Further features and advantages of the invention are apparent from the following description of embodiments with reference to the enclosed drawings.

FIG. 1 is a perspective view of a first embodiment of an equipping device.

FIG. 2 is a perspective view of a second embodiment of an equipping device.

FIG. 3 shows a first embodiment of a coating material.

FIG. 4a is a detailed view of the coating material shown in FIG. 3.

FIG. 4b is a modification of the coating material according to FIGS. 3, 4a.

FIG. 5 is a second embodiment of a coating material.

FIG. 6 shows a third embodiment of a coating material.

FIG. 7 shows a fourth embodiment of a coating material.

FIG. 8 is a detailed view of the coating material shown in FIG. 7.

FIG. 9 is a fifth embodiment of a coating material.

### DESCRIPTION OF EMBODIMENTS

Identical reference numbers that are used in different figures designate identical, corresponding or functionally similar elements.

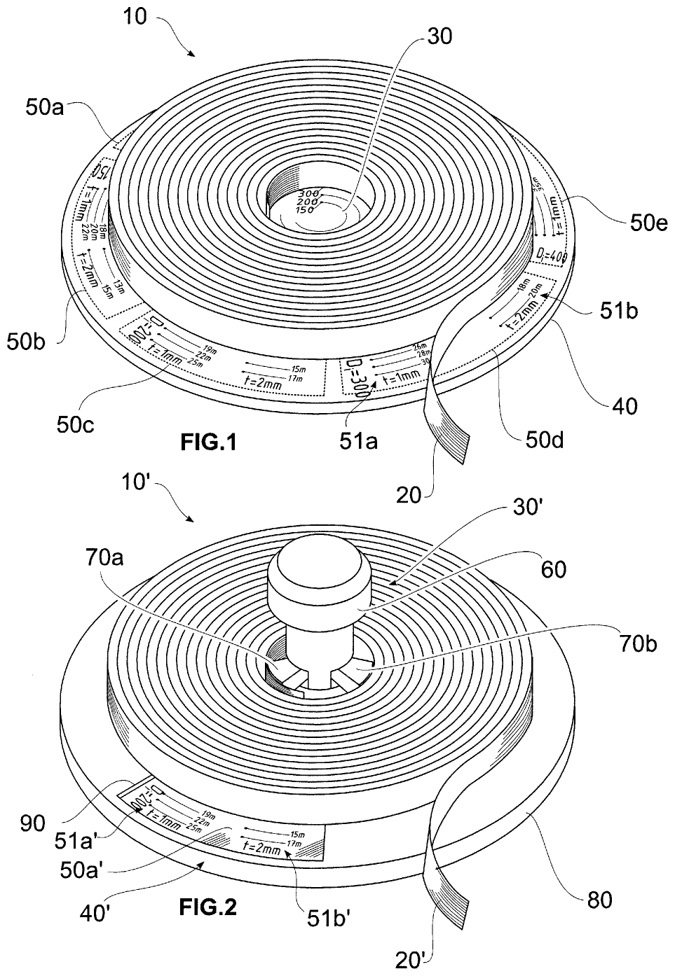

According to a first embodiment (FIG. 1), an equipping device 10 for accommodating a supply of coating material 20 is provided. The coating material 20 may be used to coat a plate-shaped workpiece, for example a workpiece consisting at least in parts of wood, wood material, composite material, plastic, aluminum, or the like. In particular, this may be a workpiece that is used in the field of furniture and components industry.

The equipping device 10 comprises a first determining means 30 which, according to the embodiment, is configured as a scale in a central area of the equipping device 10. Using the determining means 30, an inner diameter of the coating material 20 provided as roll material can be detected as a first parameter of the supply of the coating material 20.

Furthermore, the equipping device 10 comprises a second determining means 40 using which an outer diameter of the coating material 20 provided as roll material/edge band roll can be detected as a second parameter of the supply of coating material 20.

The second determining means 40 comprises a first scale group 50a, a second scale group 50b, a third scale group 50c, a fourth scale group 50d and a fifth scale group 50e. Each scale group 50a to 50e is designed for a specific outer diameter of the supply of coating material 20.

Each scale group 50a to 50e comprises a first scale and a second scale. In FIG. 1, a first scale Ma and a second scale Mb are illustrated by way of example using the scale group 50d. The first scale Ma is adapted to indicate a remaining quantity of the coating material 20 provided at the equipping device 10 having a certain (first) thickness, whereas the second scale 51b is adapted to indicate a remaining quantity of a coating material having a second thickness.

In the embodiment examples, the supply of coating material 20 is aligned with an auxiliary line for an inner diameter of 300 mm. Further common inner diameters are 150 mm, 200 mm and 400 mm. Thus, the user knows that to determine the remaining quantity of coating material 20, the fourth scale group 50d associated with this inner diameter must be observed. Thus, knowing the thickness of the coating material, the user can use the first scale 51a or the second scale 51b of the fourth scale group to determine the remaining quantity of the coating material 20 provided at the equipping device.

According to a second embodiment (FIG. 2), an equipping device 10′ for accommodating a supply of coating material 20′ is provided. Similar to the equipping device 10 of the first embodiment, the equipping device 10′ is adapted to accommodate a coating material available in roll form.

The equipping device 10′ has a first determining means 30′ which, according to the embodiment, is configured in a central area of the equipping device 10′ and is adapted to determine an inner diameter of the supply of coating material. The first determining means 30′ comprises a rotatably actuatable manipulator 60 adapted to be brought into contact with the inner diameter of the coating material 20′.

For this purpose, the first determining means 30′ comprises at least one stop 70a, 70b, which can be brought at least into a first position and into a second position by actuation of the manipulator 60, wherein the first position is associated with a first value of a first parameter, and wherein the second position is associated with a second value of the first parameter. The mentioned first and second positions are different positions of one scale.

Furthermore, the equipping device 10′ comprises a second determining means 40′ using which an outer diameter of the coating material 20′ provided as roll material can be detected as a second parameter of the supply of the coating material 20′.

Similar to the second determining means 40 of the first embodiment, the second determining means 40′ comprises a plurality of scale groups, wherein according to the second embodiment only one of the scale groups, hereinafter designated as the first scale group 50a′, is visible in a display area 90 formed as a viewing window.

If a user operates the manipulator 60 and thus brings the stop 70a, 70b into contact with the inner diameter of the coating material 20′, the corresponding scale group (here: scale group 50a′) is moved into the display area 90. The user can easily read the information there, or the information is detected by a sensor.

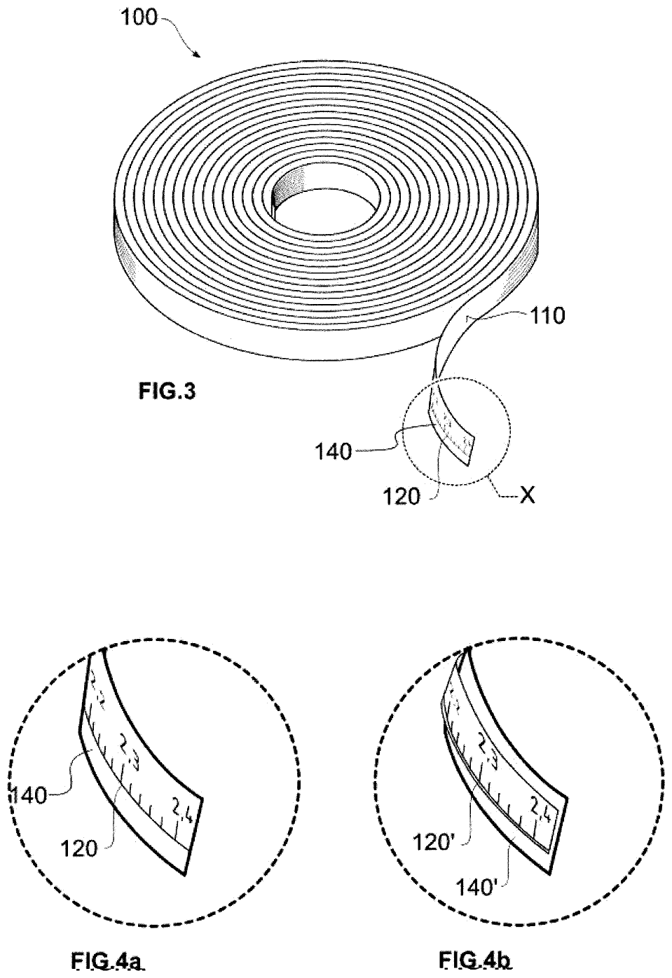

According to a further embodiment (FIG. 3), a coating material 100 is provided in the form of an edge band roll. The coating material 100 has an (imaginary) central axis.

One side of the coating material 100 is formed as a decorative surface 110. The decorative surface 110 forms the visible exterior after a workpiece has been coated. A contact surface 140 is provided on the opposite side of the coating material 100 for contacting the workpiece. The contact surface 140 may comprise an activatable layer or may be configured to receive an adhesive.

Further, the coating material 100 comprises a means, configured as a scale 120, for indicating a remaining quantity of the coating material 100, the scale 120 being provided on the contact surface 140.

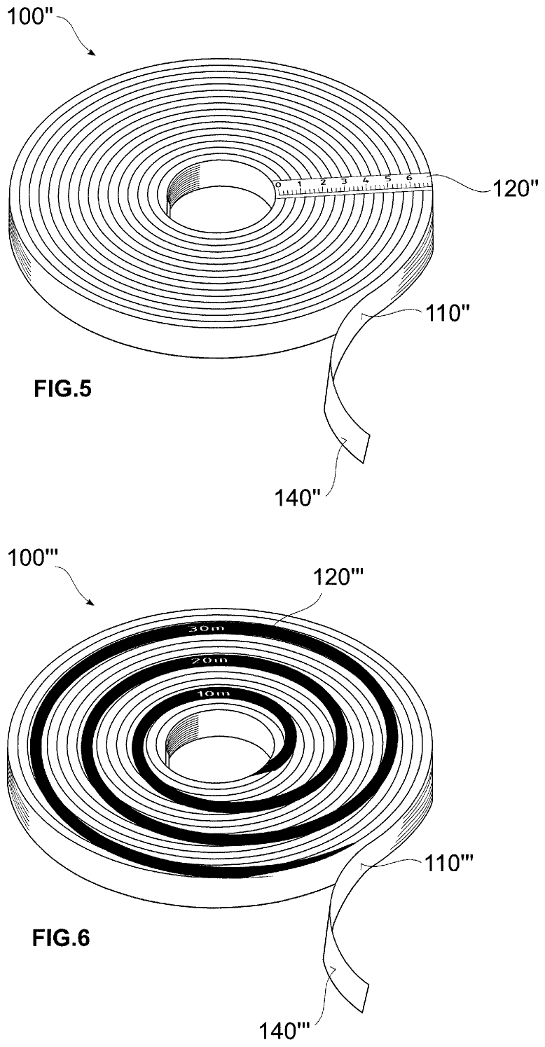

According to the embodiment shown in FIG. 3, the scale 120 is formed as an imprint on the coating material 100 (see also detailed view according to FIG. 4a).

According to a modification, however, a scale 120′ can also be a measuring tape (detailed view according to FIG. 4b) that is wound with, and in particular detachably attached to, the coating material 100′. In this case, the scale 120′ is on the side of the contact surface 140′ of the coating material 100′, although according to a modification (not shown), the scale can also be arranged on the side of the decorative surface.

When using the coating material 100′, the scale 120′ can be separated from the coating material 100′ in a coating machine.

A further embodiment is shown in FIG. 5. A coating material 100″ according to this embodiment has a decorative surface 110″ and a contact surface 140″, with a scale 120″ extending in a radial direction of the coating material 100″ formed as an edge band roll. In the embodiment example, the scale 120″ is attached to an outer surface of a hook-and-loop fastener, which provides the additional functionality of securing the coating material 100″ against unwinding. The scale 120″ is attached to an end face of the coating material 100″.

FIG. 6 shows a further embodiment of a coating material 100— which is also present as an edge band roll. The coating material 100′″ has a decorative surface 110′″ and a contact surface 140′″. Furthermore, the coating material 100′″ has a scale 120— as a means for indicating a remaining quantity of the coating material, which is printed or milled on an end face (narrow surface) of the coating material 100′″. With a coating material 100′″ in light color, this may be a dark imprint. If the coating material is formed in a dark color according to a modification, the scale is formed as an imprint in a light color.

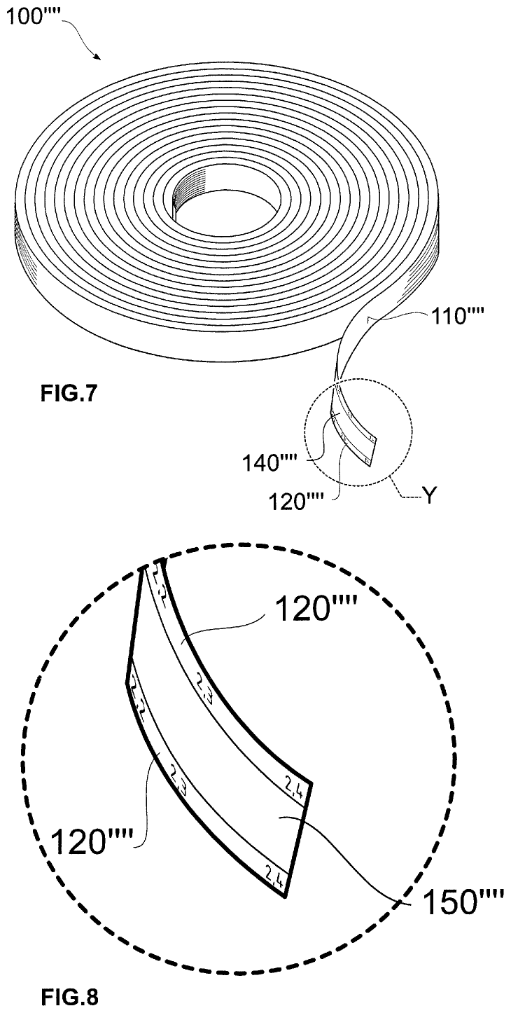

FIG. 7 and FIG. 8 show a further embodiment of a coating material 100″″, which is formed as an edge band roll as in the previous embodiments. The coating material 100″″ has a decorative surface 110″″ and a contact surface 140″″. Scales 120″″ are printed or milled on the side of the contact surface 140″″ in edge areas of the contact surface 140″″. Here, too, a dark print of the scales 120″″ can be applied to a light edge decor, or vice versa. A free area 150″″ is provided between the scales 120″″.

Since the scales 120″″ are provided in an edge area of the coating material 100″″, the scales are removed when the coating material is processed in a coating machine during the processing of protruding portions of the coating material 100″″.

Although two scales 120″″ are provided in the fourth embodiment, the coating material may comprise only one scale according to a modification.

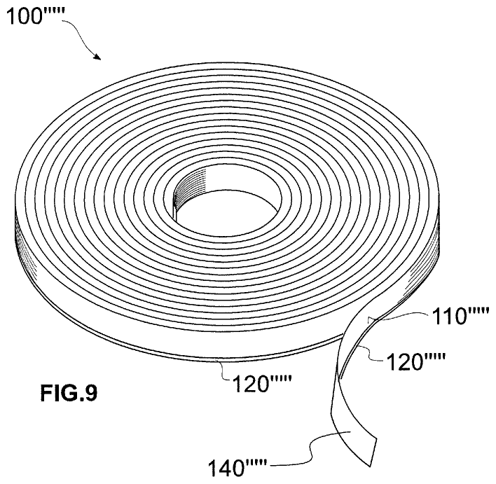

FIG. 9 shows a fifth embodiment of a coating material 100″— comprising a decorative surface 110″″ and a contact surface 140″″ similar to the previous embodiments.

A scale 120″″′ is printed or milled on the side of the decorative surface 110″″ at one of the edge areas. Similar to the embodiments previously described, a dark print of the scales 120″″ may be applied in the case of a light edge decor, or vice versa.

Since the scale 120″″ is provided in the edge area of the coating material 100″″, the scale 120″″ is removed when the coating material 100— is processed in a coating machine during the processing of protruding portions of the coating material 100″″.

Although one scale 120″″′ is provided in the fifth embodiment, the coating material may also comprise two scales in edge areas according to a modification.

The coating materials shown in FIGS. 3 to 9 may be used in an equipping device according to the embodiments shown in FIGS. 1 and 2 such that the respective advantages complement each other and may be combined.

It is apparent to the person skilled in the art that individual features described in different embodiments can also be implemented in a single embodiment, provided that they are not structurally incompatible. Similarly, various features described in the context of a single embodiment may also be provided in several embodiments either individually or in any suitable sub-combination.

1. An equipping device for accommodating a supply of coating material for coating a plate-shaped workpiece, the equipping device comprising at least one determining means for determining a parameter of the coating material.

2. The equipping device according to claim 1, wherein the determining means comprises a first determining means for determining a first parameter of the supply of coating material and a second determining means for determining a second parameter of the supply of coating material.

3. The equipping device according to claim 2, wherein the supply of coating material to be accommodated comprises an edge band roll for coating a narrow side of the plate-shaped workpiece, the edge band roll having an inner dimension, and an outer dimension, and wherein the first parameter is the inner dimension and the second parameter is the outer dimension.

4. The equipping device according to claim 2, in which the first determining means comprises a rotatably actuatable manipulator, wherein different values of the first parameter are associated with different positions of the manipulator.

5. The equipping device according to claim 4, wherein the first determining means further comprises at least one stop which can be brought at least into a first position and into a second position by actuation of the manipulator, wherein the first position is associated with a first value of the first parameter, and wherein the second position is associated with a second value of the first parameter.

6. The equipping device according to claim 5, wherein the first position corresponds to an actual position of an inner surface of a coating material having a first inner dimension, and wherein the second position corresponds to an actual position of an inner surface of a coating material having a second inner dimension.

7. The equipping device according to claim 5, wherein the stop can be brought into contact with an inner surface of a coating material by actuation of the manipulator.

8. The equipping device according to claim 4, wherein the second determining means comprises a plurality of scale groups including a first scale group and a second scale group, wherein the equipping device is further configured such that (i) bringing the manipulator into the first position causes a preselection of a first scale group of the second determining means and (ii) bringing the manipulator into the second position causes a preselection of a second scale group of the second determining means.

9. The equipping device according to claim 8, in which the first determining means is connected to the second determining means by means of an actuator element.

10. The equipping device according to claim 8, wherein when the manipulator is in the first position, the first scale group of the second determining means is in a display area, and wherein when the manipulator is in the second position, the second scale group of the second determining means is in the display area.

11. The equipping device according to claim 8, in which the first scale group comprises at least a first scale and a second scale, wherein the first scale is adapted to indicate a remaining quantity of a coating material having a first thickness, and wherein the second scale is adapted to indicate a remaining quantity of a coating material having a second thickness.

12. The equipping device according to claim 1, in which the determining means comprises: one or more cameras; one or more optoelectronic sensors; one or more capacitive sensors; one or more ultrasonic sensors; one or more radar sensors; or one or more light barriers.

13. The equipping device according to claim 2, in which the first determining means comprises an input means for inputting the first parameter and for inputting a third parameter.

14. The equipping device according to claim 1, wherein the determining means comprises weighing scales for determining a mass of the supply of coating material.

15. The equipping device according to claim 1, further comprising an output device for outputting a remaining quantity of a supply of coating material to be provided.

16. A coating machine for coating a narrow side of a plate-shaped workpiece, wherein the coating machine comprises at least one coating unit and an equipping device according to claim 1.

17. (canceled)

18. Coating material for coating a plate-shaped workpiece wherein the coating material comprises a means for indicating a remaining quantity of coating material.

19. The coating material according to claim 18, wherein the means for indicating a remaining quantity of coating material comprises a scale.

20. The coating material according to claim 18, wherein the means for indicting a remaining quantity of coating material is provided in one or two edge areas of the coating material.

21. The coating material according to claim 18, wherein the means is attached on a contact surface of the coating material, a decorative surface of the coating material, or an end face of the coating material.

22. The coating material according to claim 21, wherein the means is glued on or attached on the contact surface of the coating material by means of a hook-and-loop fastener, printed, notched, or milled in.

23. The equipping device according to claim 9, wherein the actuator element comprises: (i) a gear unit such as a spur gear, a planetary gear, a belt gear, a friction gear, or a rack-and-pinion gear; (ii) a rigid connection between the manipulator and at least one component of the second determining means; or (iii) a drive, an electrically operable drive, a hydraulically operable drive, or a pneumatically operable drive.
